(19) United States
(12) Patent Application Publication
(10) Pub. No.: US 2010/0067172 A1
(43) Pub. Date: Mar. 18, 2010

(54) HIGH ELECTRIC ENERGY DENSITY POLYMERIC COMPOSITIONS, METHODS OF THE MANUFACTURE THEREFOR, AND ARTICLES COMPRISING THE SAME

(75) Inventors: Shihai Zhang, State College, PA (US); Qiming Zhang, State College, PA (US)

Correspondence Address: GIFFORD, KRASS, SPRINKLE,ANDERSON & CITKOWSKI, P.C, PO BOX 7021, TROY, MI, 48007-7021, US

(73) Assignee: Strategic Polymer Sciences, Inc.

(21) Appl. No.: 12/403,596

(22) Filed: Mar. 13, 2009

Related U.S. Application Data
(60) Provisional application No. 61/036,095, filed on Mar. 13, 2008.

(51) Int. Cl. H01G 4/08

(52) U.S. Cl. 361/323

(57) ABSTRACT

Examples of the present invention relate generally to high electric energy density polymer film capacitors with high charge-discharge efficiency and fast discharge speed. For example, a high energy density polymer capacitor may be fabricated using a polymer blend comprising one or more high dielectric constant PVDF-based polymers (including homopolymers, copolymers and/or terpolymers) and one or more other polymer with low dielectric loss and high volume resistivity compared to the one or more PVDF-based polymers. An example film capacitor may comprise a high temperature fluoropolymer with dielectric loss lower than 0.2% and good film manufacturability. Polymer films can be stretched and orientated at least in one direction to make thinner films with improved performance. Film capacitors can be made by winding metallized films, plain films with metal foils, or using a hybrid construction where the dielectric films comprise the new compositions. Capacitors can also have a multilayer construction where the films are metallized.

### REFERENCE TO RELATED APPLICATIONS

This application claims priority to U.S. provisional patent application Ser. No. 61/036,095, filed Mar. 13, 2008, the entire content of which is incorporated herein by reference.

### STATEMENT REGARDING GOVERNMENT SUPPORT

This invention was made with Government support under contract No. FA8650-07-M-2791 awarded by the Air Force Research Lab. The US Government has certain rights in this invention

### FIELD OF THE INVENTION

The present invention relates generally to high electric energy density polymers, and applications thereof such as polymer thin film capacitors.

### BACKGROUND OF THE INVENTION

The commercial and consumer requirements for compact and more reliable electric power and electronic systems have grown substantially over the past decade. As a result, development of high electric energy and power density capacitor technology has grown to become a major enabling technology.

For a typical parallel plate capacitor, the capacitance C is given by:

C=Kε₀A/t (1)

wherein K is the dielectric constant (relative permittivity), A is the area and t is the thickness of the capacitor, and ε₀ is a constant (vacuum permittivity, and =8.85×10⁻¹² F/m).

For linear dielectric materials, electric energy density varies according to:

U=½Kε₀E² (2)

wherein E is the electric field in the capacitor.

Energy densities of nonlinear dielectrics are derived from the relationship

U=∫EdD (3)

where D is the electric displacement.

FIG. 1 presents a typical charge-discharge cycle of capacitors with nonlinear dielectrics. During the charging process, the amount of energy Uc is stored into the capacitor (area a+b). At the highest voltage, the capacitor is connected to a resistive load and the electric energy is discharged. The discharged energy Ud (area b) is usually smaller than Uc. The difference between Uc and Ud (area a) represents the energy lost during the charge-discharge cycle. The energy loss consists of leakage current, dielectric loss, and ferroelectric remnant charge.

The charge-discharge efficiency η of the dielectrics and capacitors is therefore defined as:

η=Discharged energy/Charged energy×100% (4)

Although ceramic-based dielectric materials usually have very high dielectric constant (i.e., >100), the relatively low breakdown field (<50 MV/m) and the catastrophic failure behavior in the ceramic capacitors result in a low electric energy density (<1 J/cm3).

High charge-discharge efficiency is important for many capacitor applications. It not only improves the energy utilization efficiency, but also prevents capacitor failure from temperature raise. The lost electric energy is usually converted into thermal energy and increases the internal capacitor temperature, particularly at high-duty cycle (high repetition rates) applications such as power electronics and hybrid electric vehicles.

### SUMMARY OF THE INVENTION

Examples of the invention include polymeric materials, such as polymer blends, which may be used as dielectric films. Examples of the invention include capacitors including polymer films, which may have high charge-discharge efficiency and a fast discharge speed. More particularly, examples include a high energy density polymer capacitor comprising a dielectric film including a polymer blend. The polymer blend may include at least a first polymer and a second polymer, the first polymer being a fluoropolymer such as a PVDF-based polymer. The second polymer may be another polymer having a low dielectric loss and a high volume resistivity.

Examples also include film capacitors comprising a high temperature fluoropolymer with dielectric loss lower than 0.2% and good film manufacturability. Film capacitors according to examples of the present invention can be used in numerous applications, such as power electronics apparatus including hybrid electric vehicles, and defibrillators. Examples of the present invention include devices for storing, controlling, and manipulation of electric charge, electric energy, and electric power, with high efficiency.

Examples of the present invention include improved polymer materials such as polymer blends, and charge or energy storage devices having a charge or energy storage layer including a polymer blend.

A polymer blend according to an example of the present invention may comprise a first polymer and a second polymer, the first polymer being a fluoropolymer, and the second polymer being a polymer having a volume resistivity greater than the first polymer and/or a dielectric loss less than the first polymer.

In representative examples, the first polymer (which in this specification may sometimes be referred to as a type-A polymer) is a fluoropolymer, such as a PVDF-based fluoropolymer, which may include homopolymers, copolymers, terpolymers, or other polymers of vinylidene fluoride (also termed vinylidene difluoride, or VDF). Example polymers include polyvinylidene fluoride (PVDF), poly(vinylidene fluoride-co-chlorotrifluoroethylene) (PVDF-CTFE), poly(vinylidene fluoride-co-hexafluoropropylene) (PVDF-HFP), poly(vinylidene fluoride-co-chlorofluoroethylene) (PVDF-CFE), poly(vinylidene fluoride-co-chlorodifluoroethylene) (PVDF-CDFE), poly(vinylidene fluoride-co-trifluoroethylene-co-chlorofluoroethylene) (PVDF-TrFE-CFE), poly(vinylidene fluoride-co-trifluoroethylene-co-chlorotrifluoroethylene) (PVDF-TrFE-CTFE), poly(vinylidene fluoride-co-trifluoroethylene-co-hexafluoropropylene) (PVDF-TrFE-HFP), poly(vinylidene fluoride-co-trifluoroethylene-co-chlorodifluoroethylene) (PVDF-TrFE-CDFE), poly(vinylidene fluoride-co-tetrafluoroethylene-co-chlorofluoroethylene) (PVDF-TFE-CFE), poly(vinylidene fluoride-co-tetrafluoroethylene-co-chlorotrifluoroethylene) (PVDF-TFE-CDFE), poly(vinylidene fluoride-co-tetrafluoroethylene-co-hexafluoropropylene) (PVDF-TFE-HFP), poly(vinylidene fluoride-co-tetrafluoroethylene-co-chlorodifluoroethylene) (PVDF-TFE-CDFE). Examples also include derivatives of such polymers. Examples also include blends comprising one or more of such polymers, or derivatives thereof.

The second polymer (which in this specification may be termed a type-B polymer) may be selected from polymers or polymer blends that have one or more of the following parameters: a dielectric dissipation factor (DF) lower than 5%, a dielectric constant above 2.0, and a volume resistivity above 10¹⁴ Ω·cm.

Example second polymers include polystyrene, polycarbonate, poly(2,6-dimethy-1,4-phenylene oxide) (PPO), poly(ethylene-co-tetrafluoroethylene) (ETFE), polyethylene naphthalate (PEN), poly(phenylene sulfide) (PPS), and the like.

The second polymer may also be referred to as a blending polymer, the blending polymer being blended with a PVDF-based polymer to produce a polymer blend having one or more improved properties.

In some examples, a compatibilizer may be used to facilitate miscibility of the first and second polymers in a polymer blend. In some examples, the second polymer and/or the first polymer may be chemically modified to facilitate miscibility of the first and second polymers.

In some examples, the second polymer may be polypropylene (PP). Polypropylene can used as a blending polymer to form blends with a PVDF-based polar fluoropolymer. However,

A compatibilizer such as an acrylate, an acrylate acid, an epoxy, or maleic anhydride modified polypropylene (or polyethylene) can be used to facilitate the miscibility of polymers in the polymer blend.

The polymer blends can be prepared by solution mixing, melt mixing, or other process. In an example solution mixing approach, the component polymers are dissolved in a common solvent or solvent mixture, and then the film is cast from the solution. In an example melt mixing approach, the component polymers are mixed with a single screw extruder or twin screw extruder in the melt state. A polymer blend can be prepared by melt extrusion or solution casting. Polymer blend films, such as dielectric films, can be further stretched in at least one direction.

Similarly, a capacitor film can be obtained directly from solution casting, or solution casting followed by orientation in either one or two directions. A capacitor film can be obtained by melt extrusion through a film die, and then stretched in either one direction or two directions. A capacitor film can be obtained by extrusion blowing or double-bubble blowing with or without further stretching.

A high electric energy density (>4 J/cm³) with fast discharge speed (less than 0.1 seconds) and high efficiency (>80%) can be achieved using a polymer blends described herein as capacitor dielectric layers, which combine high electric breakdown strength, high energy density, low dielectric dissipation factor, high volume resistivity, and high dielectric constant.

High energy density polymer film capacitors, in particular those with charge-discharge efficiency above 80%, have applications in a broad range of power electronics and electric power systems such as these used in defibrillators, hybrid electric vehicles, and in electric weapons.

Accordingly, examples of the present invention include a new class of film capacitors comprising modified PVDF compositions by blending PVDF-based fluoropolymers with other polymers which have low dielectric dissipation factor and high volume resistivity. The PVDF fluoropolymers include PVDF-based homopolymers, copolymers and terpolymers, e.g. polymers, copolymers, and terpolymers of vinylidene fluoride (VDF, also called 1,1-difluoroethene), and derivatives thereof.

In some examples, the first polymer is a fluoropolymer or a blend of fluoropolymers, the fluoropolymer being ferroelectric in that the neat fluoropolymer has a ferroelectric phase, although a non-ferroelectric phase (e.g. alpha phase) of the polymer blend may be desirable to reduce losses. The second polymer may be non-ferroelectric, in that it does not have any ferroelectric phase in the neat form.

The second polymer may be a thermoplastic polymer that is not ferroelectric in any of its phases. In some examples, the second polymer is an oxygen-containing polymer (e.g. a polycarbonate or a polyester), or in some examples a sulfur containing polymer.

An electric energy density of at least 25 J/cm³ can be obtained in the improved polymer blends. Improved film capacitors according to examples of the invention combine the high electric energy density of PVDF polar fluoropolymers and the high charge-discharge efficiency of the other component(s), e.g. one or more blending polymers described herein as possible second polymers.

Examples of the present invention also include a high temperature fluoropolymer with low dielectric dissipation factor and excellent thin film manufacturability, and application as a dielectric film in a capacitor.

### BRIEF DESCRIPTION OF THE DRAWINGS

Further features and advantages of the present invention can be understood by reference to the drawings and detailed description that follow.

FIG. 1 is a graph schematically illustrating a typical charge-discharge cycle of nonlinear dielectrics.

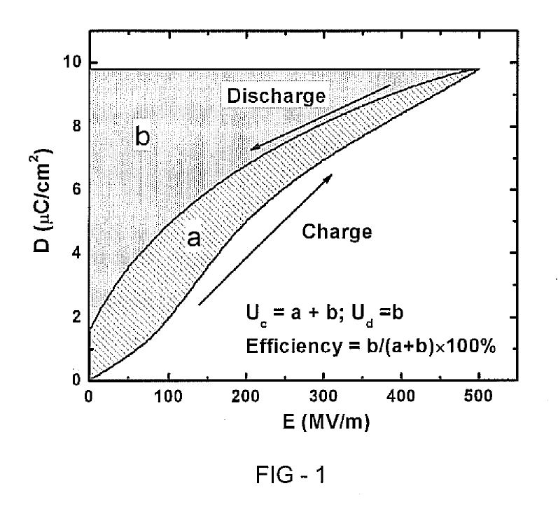

FIG. 2 is a graph summarizing the discharged energy density in PVDF polar fluoropolymers, PP, and PC.

FIG. 3 summarizes the dielectric breakdown strength of metallized P(VDF-HFP) and its blends with polycarbonate. The x-axis labels refer to the weight content of PC in the blend.

FIGS. 4A and 4B present the low-field dielectric constant and dissipation factor of P(VDF-HFP)/PC blends as a function of temperature at 1 kHz, respectively. In the figure, the wt % of PC in the blends and dielectric constant in FIG. 4A and loss in FIG. 4B are labeled in the inserts.

FIGS. 5A and 5B summarize the discharged energy density and charge-discharge efficiency of metallized PC/P(VDF-HFP) blend capacitor films.

FIG. 6 illustrates the charge-discharge cycle of P(VDF-HFP)/PC blends with 0, 40%, 50%, and 100% PC concentrations.

FIG. 7 summarizes the dielectric constant (square symbols) and dissipation factor (triangle symbols) of ETFE capacitor films.

FIG. 8 summarizes the Weibull dielectric breakdown strength of stretched ETFE film (both surfaces of the film are metallized) at different temperatures. Standard deviation also provided. The films are 6-8 μm thick.

FIG. 9 summarizes the charge-discharge efficiency of stretched ETFE capacitor film (both surfaces of the film are metallized).

FIGS. 10A and 10B show the dielectric constant and dissipation factor of P(VDF-HFP)/ETFE blend capacitor film as function of temperature at 1 kHz.

FIG. 11 illustrates the charge-discharge cycle of P(VDF-HFP)/ETFE blend with 70% ETFE capacitor film at different electric field.

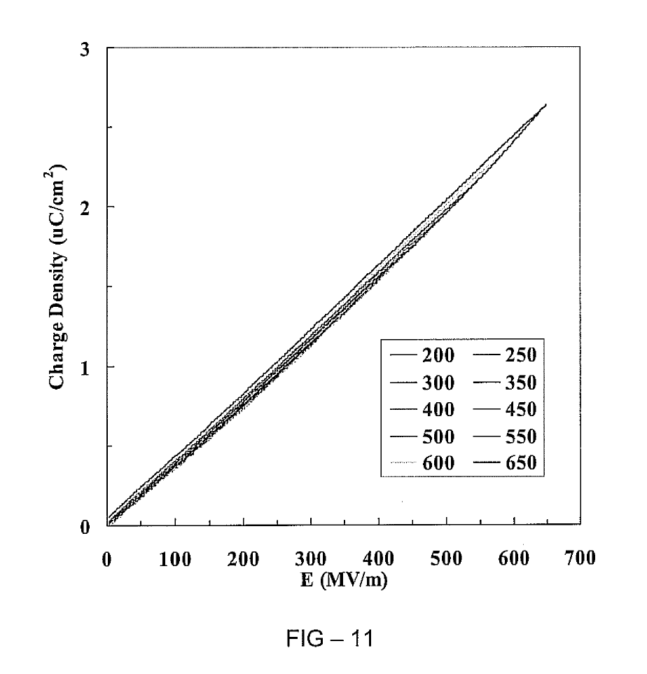

### DETAILED DESCRIPTION OF THE INVENTION

Improvements in the electrical properties of polymer dielectric films can be established from an understanding of the charge-discharge process in dielectric materials at the molecular level. In fluoropolymers such as PVDF, the leakage current and the ferroelectric loss dominate the energy loss. Therefore, to improve the charge-discharge efficiency, the volume resistivity is increased and the polymer chain is preferably not in the all trans conformation.

The PVDF-based fluoropolymers typically have a volume resistivity <10¹⁴ Ω·cm at electric fields above 25 MV/m, which is significantly lower than polypropylene (PP) and polycarbonate (PC), which have a volume resistivity of around 10¹⁷ Ω·cm. The relatively low volume resistivity of the polar fluoropolymers leads to a high leakage current under high electric field, which in turn results in a low capacitor charge-discharge efficiency. Therefore, by blending a PVDF-based polymer with one or more other polymers that have a higher volume resistivity, the leakage current of the resulting polymer blend can be reduced compared with the PVDF-based polymer in an unblended form, and further the capacitor charge-discharge efficiency can be effectively improved.

In PVDF-based fluoropolymers, there are different molecular conformations and a reversible switch between the polar and non-polar conformations can result in a large polarization change, with the potential to reach a high energy density (see equation (3)). Energy densities above 25 J/cm3 can be achieved in metallized capacitor films.

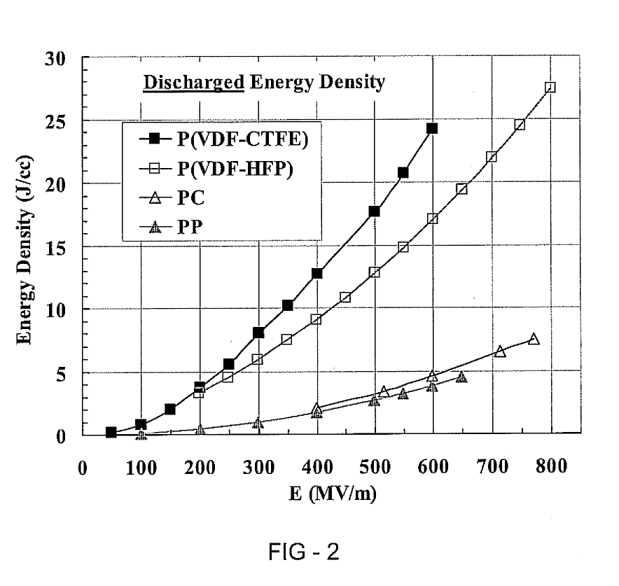

FIG. 2 summarizes the discharged energy density measured from metallized PVDF copolymer films and PP, PC films. However, these polar fluoropolymers have dielectric dissipation factor (DF) around 1% to 5% at low electric field, and a charge-discharge efficiency less than 75% at electric field above 200 V/μm. As a comparison, the low-K PP and PC have charge-discharge efficiency above 95% at the same field. Examples of the present invention include blends of polar fluoropolymers and (low-K) polymer films having a higher discharge efficiency than the polar fluoropolymers.

The PVDF-based fluoropolymers can be converted into the β crystalline phase with all trans chain conformation by stretching of the film, which is the state-of-the-art procedure to make commercial capacitor thin films. However, the β crystalline phase has high ferroelectric remnant loss and not desirable for capacitor energy storage applications. By blending with other polymers with proper compositions, the stretching force can be carried by the non-PVDF polymer chains, minimizing the conversion of PVDF chains to β phase and increasing the charge-discharge efficiency.

Hence, examples of the present invention include stretched polymer blends including one or more fluoropolymers, such as polar fluoropolymers, in which the β phase formation is reduced, compared with an unblended polar fluoropolymer.

In addition, the blending polymers may also have lower DF than PVDF-based fluoropolymers and thus, the DF of the blends can be reduced, further improving the capacitor charge-discharge efficiency.

Polymers useful for thin film capacitor applications may have a low dielectric constant (such as <4), but a very high breakdown field (>600 MV/m) that allows a relatively high energy density to be achieved. For example, biaxially oriented polypropylene (BOPP) has a relatively low dielectric constant of 2.2, and yet the high breakdown field (˜600 MV/m) allows a maximum electric energy density of more than 3.5 J/cm3.

Other polymers useful for film capacitor applications include polycarbonate (PC, K=3.1), polyethylene terephthalate (PET, K=3.3), polyethylene naphthalate (PEN, K=3.2), and poly(phenylene sulfide) (PPS, K=3.1). Examples of the present invention include polymer blends of such non-polar polymers with a polar polymer, so as to allow improvement in one or more properties relative to the unblended polymers.

Since the blending polymers may have higher thermal stability than PVDF polar fluoropolymers, the blends can also improve the temperature rating of the capacitors relative to using a PVDF polar fluoropolymer alone.

The properties of polymer blends can be easily tailored through the selection of different components and by employing various processing methods. Therefore, blending of two or more polymers has become an economical route to develop new materials to meet many challenging requirements for industrial applications. Blending the PVDF polar fluoropolymers with other polymers with low DF and high volume resistivity is likely the most time-saving and cost-efficient approach to improve the capacitor charge-discharge efficiency.

Preferably, polymers within the polymer blends are miscible or at least partially miscible. Immiscible polymers can show phase separation at micrometer scale, which is comparable with the thickness of capacitor film (<10 μm). This immiscibility may introduce nonuniformity, reducing the dielectric breakdown strength and mechanical properties. The interface between the two micro-phases also leads to the well-known interface polarization, which is usually correlated with dramatically increased dielectric dissipation factor at low frequencies.

On the other hand, miscible or partially miscible polymer blends are uniform at the molecular level and can effectively achieve the desired electrical/mechanical properties without compromising the dielectric breakdown strength. In addition, high quality film can be readily manufactured directly using the current low-cost commercial processing methods such as blown extrusion (double-bubble) or biaxial stretching (tender frame).

The miscibility of two polymers can be described by Flory-Huggins theory:

ΔGₘ=RT[n₁lnφ₁+n₂lnφ₂+n₁φ₂χ₁₂] (5)

where ΔGₘ is the change of free energy by mixing and it is generally negative for miscible blends. Here, nᵢ and φ₁ are moles of polymer chains and volume fraction of component i, respectively. χ₁₂ is the interaction parameter between two components, it is negative for intermolecular attraction and positive for repulsion. In the Flory-Huggins equation, the first two items represent the change of entropy and it is usually a small number since polymer chains have high molecular weight. Therefore, a miscible polymer blend requires a very small positive χ₁₂ or negative χ₁₂ (enthalpy).

PVDF-based polymers are miscible with poly(methyl methacrylate) (PMMA) due to the weak hydrogen bonding, which leads to a negative χ. Although the blends have comparable dielectric breakdown strength as PVDF, the dielectric DF is not reduced since PMMA has a higher DF (>5%) than PVDF. Therefore, to achieve the miscibility and reduce DF, polymers with low DF and electron-donor groups (such as C═O, —O—, S═O, —S—, ═N—) can be used.

If the second polymer has high melting temperature (Tₘ) or glass transition temperature (T_{g}), the thermal stability of the final polymer blend and capacitor application can be increased.

Polymers with similar chemical structures are usually miscible since their interaction parameter is close to zero.

Based on the above two principles, polymers including strong polar groups, or low-dissipation factor fluoropolymers are potentially miscible or partially miscible with PVDF-based fluoropolymers.

Table I provides a list of possible blending polymers which have low DF and high volume resistivity polymers, though the invention is not limited to these representative examples.

TABLE I
Dielectric properties of selected low DF and high volume resistivity dielectric
materials (T_{g}: glass transition temperature, and Tₘ: melting temperature)

| | Dielectric | Dielectric | | T_{g} | Tₘ |
|---|---|---|---|---|---|
| | constant | loss | Resistivity | (° C.) | (° C.) |
| Polycarbonate(PC) | 3.1 | 0.2% | >10¹⁷ Ωcm | 149 | 267 |
| Poly(2,6-dimethyl-1,4-phenylene | 2.8 | 0.05% | >10¹⁶ Ωcm | 220 | |
| oxide) (PPO) | | | | | |
| Polyethylene terephthalate (PET) | 3.3 | 0.2% | >10¹⁶ Ωcm | 78 | 245 |
| Polyethylene naphthalate (PEN) | 3.2 | 0.5% | >10¹⁶ Ωcm | 120 | 280 |
| Poly(ethylene-co- | 2.7 | 0.08% | >10¹⁷ Ωcm | | 265 |
| tetrafluoroethylene) (ETFE)) | | | | | |
| Teflon AF | 2.0 | 0.02% | >10¹⁷ Ωcm | | >300 |
| Polyetheretherketone (PEEK) | 3.3 | 0.35% | >10¹⁶ Ωcm | 157 | 374 |
| Poly(phenylene sulfide) (PPS) | 3.1 | 0.06% | >10¹⁷ Ωcm | 88 | 280 |
| Polyether imide (PEI) | 3.2 | 0.35% | >10¹⁶ Ωcm | 217 | |
| Polysulfone | 3.0 | 0.1% | >10¹⁶ Ωcm | 190 | |
| P(MDA/MDI) (MDA: 4,4′- | 4-14 | 1% | | | >200 |
| diaminodiphenylmethane; MDI: | | | | | |
| 4,4′-diphenylmethane diisocyanate) | | | | | |

Polypropylene has a dielectric dissipation factor less than 0.1% and a volume resistivity above 1017 Ω·cm. However, it is a nonpolar polymer and is not miscible with PVDF-based polar fluoropolymers. In order to promote miscibility, a compatibilizer such as acrylate, acrylate acid, epoxy, or maleic anhydride modified polypropylene or polyethylene can be used. A dielectric layer comprising a blend of at least one polar fluoropolymer, a polypropylene, and a compatibilizer may have the desired high electric energy density and high charge-discharge efficiency.

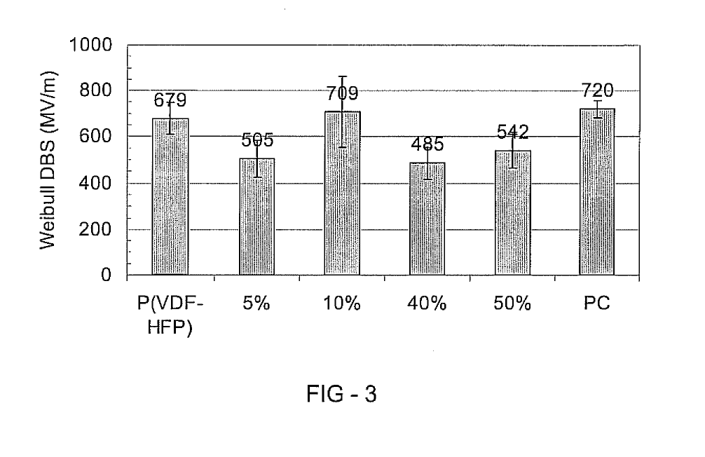

Polycarbonate (PC) has been used for film capacitor applications for many years and commercial capacitor films with thickness below 1 μm are available. PC has a glass transition temperature of 149° C., K of 3.1, DF less than 0.2%, and volume resistivity above 10¹⁷ Ω·cm. Its dielectric breakdown strength is over 700 V/μm (FIG. 3) and energy density up to 7 J/cc (FIG. 2). The carbonate group in PC (O—CO—O) is a highly polar group similar to these in PMMA, and they can interact with the hydrogen in PVDF-HFP, promoting miscibility.

The polymer blend films were stretchable even with PC above 30% by weight. A weight composition of 30%-70% PC in a polymer blend with one or more PVDF-based polymers was found to improve the dielectric performance of dielectric films formed using these polymer blends.

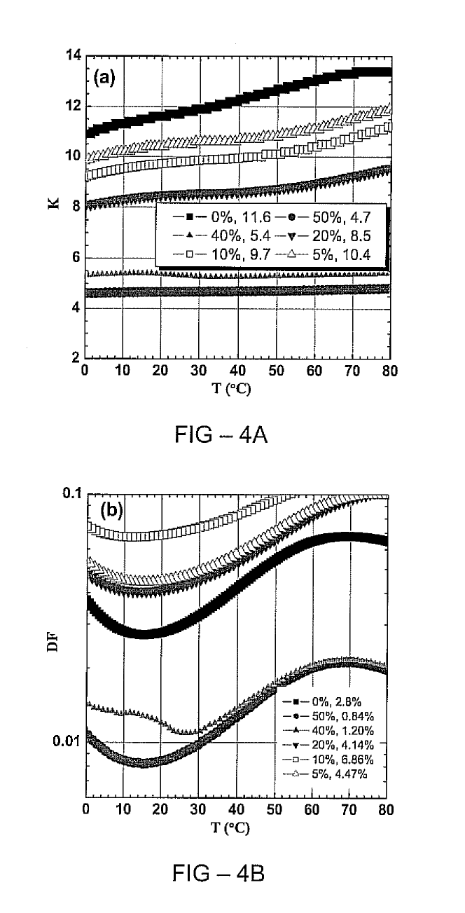

FIGS. 4A and 4B summarize the low field dielectric performance of the PC/P(VDF-HFP) blends. Since PC has a lower K than P(VDF-HFP), K gradually decreases with increasing PC content, as shown in FIG. 4A. For blends with 50% PC, K is only 4.7 at 1 kHz at 20° C. On the other side, DF exhibits complex trend in the blends, as shown in FIG. 4B. Blends with 5%-20% PC have slightly higher DF than neat P(VDF-HFP), but the blends with 40% and 50% PC have a DF of 1.2% and 0.84% at 1 kHz and 20° C., respectively. DF increases at high temperature, but it is still ˜70% lower than neat P(VDF-HFP).

The PCIP(VDF-HFP) blends also have high dielectric breakdown strength. FIG. 3 compares the dielectric breakdown strenght (DBS) of blends with neat polymers. The P(VDF-HFP), 5%, 10%, and 40% blends are stretched blown films, and the 50% blend is as-blown film. These four blend films show reasonable DBS. The 40% blend film has dielectric breakdown strength of 485 MV/m. Particularly, the unstretched 50% blend has a Weibull dielectric breakdown strength of 542 V/um and DF less than 1%. The Weibull dielectric breakdown strength is defined in Eq (6):

$${P}_{f} = 1 - exp [ - {( \frac{E}{{E}_{b}} )}^{β} ] \qquad ( 6 )$$

where E is the measured breakdown electric strength. β is the shape parameter and a larger β is preferred since it corresponds to a narrower breakdown strength distribution. E_{b} is the Weibull breakdown strength (63.2% of accumulated probability for breakdown). To achieve statistical significance, usually more than 20 specimens were tested for one sample.

Although K of the 50% blend decreases to 4.7, it is still ˜50% higher than neat PC. With its high DBS, the blend also has high UE.

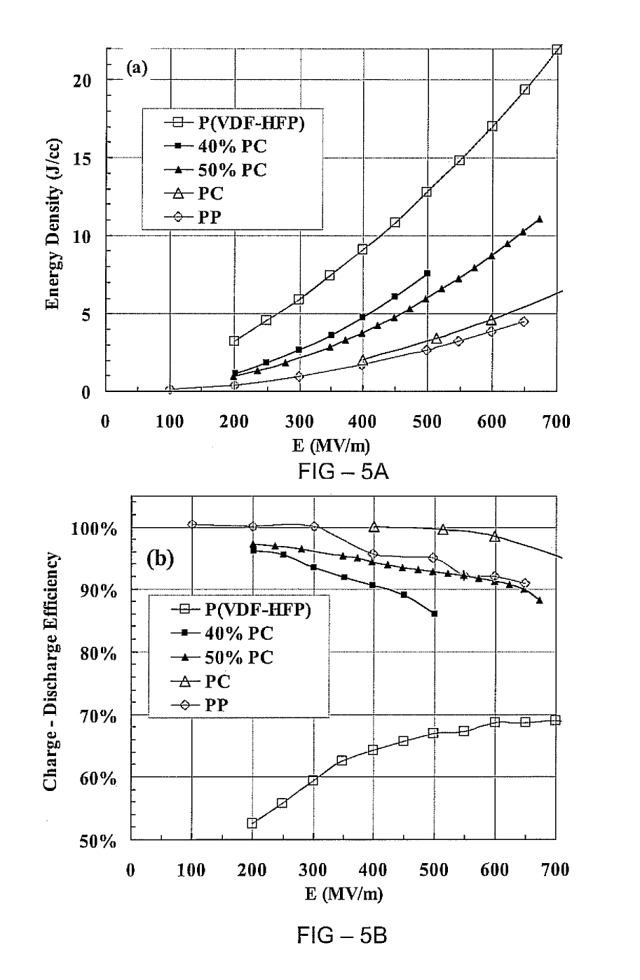

FIGS. 5A and 5B compare the discharged energy density of the PC/P(VDF-HFP) blends and related neat polymers.

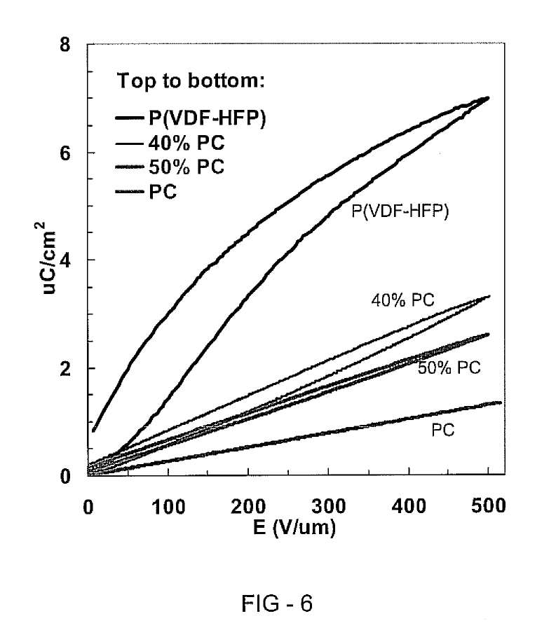

FIG. 6 illustrates the charge-discharge cycle of the blends and the neat polymers at 500 MV/m. It is clear that the energy loss during the charge-discharge cycle has dramatically reduced. At 500 V/μm, the neat P(VDF-HFP) has a discharged energy density of 11.4 J/cc, which decreases to 7.6 J/cc in the 40% blend. The energy density further decreased to 6.0 J/cc for the 50% blend. However, the energy density of the 50% blend is still ˜76% higher than the neat PC (3.4 J/cc) at the same electric field. At 500 V/μm, commercial BOPP capacitor film has an energy density of only 2.5 J/cc (FIG. 2), and the 50% blend film has an energy density that is 140% higher than BOPP. The discharged energy density achieved in the 50/50 blend is 11 J/cc at 675 V/μm.

Table II summarizes the results of the PC/P(VDF-HFP) blends.

TABLE II
Summary of the Electric Properties of PC/P(VDF-HFP) Blends ^{a}

| | | Dielectric | Dielectric | Discharged | Charge- | |
|---|---|---|---|---|---|---|
| | Dielectric | Dissipation | Breakdown | Energy | Discharge | Volume |
| | Constant | Factor | Strength | Density | Efficiency | Resistivity |
| PC % | (1 kHz) | (1 kHz) | (MV/m) ^{b} | (J/cm³) ^{c} | (%) ^{c} | (Ω · cm) ^{d} |
| P(VDF- | 11.6 | 2.8% | 679 | 11.4 | 71.4 | 4.53 × 10¹³ |
| HFP) | | | | | | |
| 5% | 10.4 | 4.5% | 505 | 11.1 | 64.4 | |
| 10% | 9.7 | 6.9% | 709 | 9.7 | 66.9 | |
| 20% | 8.5 | 4.1% | Cannot | | | |
| | | | stretch | | | |
| 30% | | | Cannot | | | 2.65 × 10¹⁵ |
| | | | stretch | | | |
| 40% | 5.4 | 1.2% | 485 | 7.6 | 86.0 | 9.39 × 10¹⁵ |
| 50% | 4.7 | 0.8% | 542 | 6.0 | 92.8 | 5.26 × 10¹⁵ |
| PC | 3.1 | 0.2% | 720 | 3.4 | 99.4 | 1 × 10¹⁷ |

^{a} all measured at room temperature.
^{b} Weibull.
^{c} at 500 MV/m.
^{d} at 25~50 MV/m

Consistent with its reduced DF at low field, the charge-discharge efficiency of the 40% and 50% blend has been dramatically improved to 86.0% and 92.8%, respectively, at 500 V/μm, approaching that of neat PC. It is only 71.4% for neat P(VDF-HFP) at 500 V/μm. The energy loss during the charge-discharge includes contributions from DF, ferroelectric loss, and leakage current. It is clear that all three contributions have been decreased by blending with PC at proper compositions. Particularly, the electric volume resistivity exhibits the biggest increase, from ˜10¹³ Ω·cm for neat P(VDF-HFP) to >10¹⁵ Ω·cm for the 40% and 50% blends (Table II).

From results shown in Table II, for blends with PC concentration equal to or lower than 20% by weight, there is no significant improvement in the charge-discharge efficiency. On the other hand, for blends with PC concentration higher than 80% by weight, the dielectric constant of the blends is too low. Therefore, the preferred compositions of the PC/P(VDF-HFP) blends is 30/70 to 80/20 by weight.

Similar compositional ranges may similarly give improved performance for other polymer blends according to examples of the present invention. The weight percentage of the second polymer (the type-B polymer) may be in the range of about 30% to about 80%, more particularly from about 40% to about 70%.

A PC/P(VDF-HFP) blend capacitor film can be stretched since PC has a T_{g} of 149° C., below the melting temperature of P(VDF-HFP). Polymer films are usually stretched at temperatures above T_{g} and below Tₘ. The polymer blend films can be stretched at temperatures above 149° C., or other appropriate temperature. Blend films with PC as the matrix (blending polymer) can also be stretched above the melting temperature of P(VDF-HFP) since PC can provide the required mechanical strength.

The charge-discharge efficiency of PVDF polar fluoropolymers can also be improved by blending with another nonpolar fluoropolymer such as poly(ethylene-co-tetrafluoroethylene) (ETFE). ETFE is a melt processible high temperature polymer, also known as DuPont™ Tefzel®, (E/TFE˜50/50 mol). It has very low dielectric DF (0.05%), and high thermal stability (rated up to 200° C.).

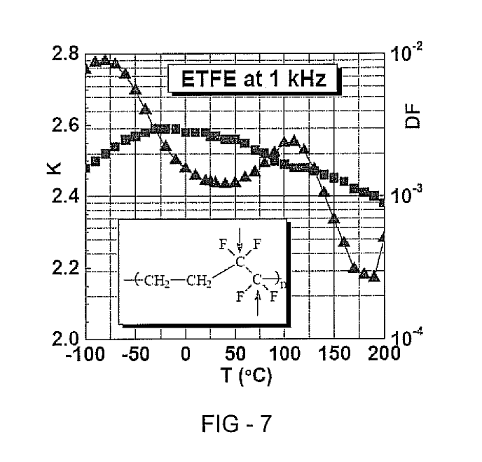

FIG. 7 presents the dielectric constant and dissipation factor of ETFE at 1 kHz as a function of temperature. Examples of the present invention include capacitors having a dielectric layer comprising or consisting essentially of ETFE.

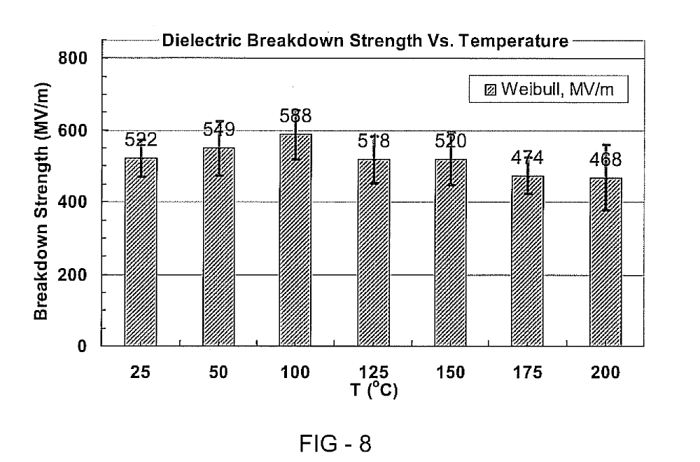

FIG. 8 compares the dielectric breakdown strength of stretched ETFE thin film at different temperatures. The films were metallized with gold on both sides before test. The stretched ETFE film has Weibull DBS of 522 V/μm at 25 ° C., and it surprisingly increases to 588 V/μm at 100° C., and then slightly decreases at higher temperatures. However, even at 200° C., its Weibull DBS is still as high as 468 V/μm with maximal DBS of 610 V/μm. The ETFE film tested here is industrial grade. The breakdown strength can be improved by removing resin impurities/additives and film defects using improved resin and film quality specially produced for capacitor applications.

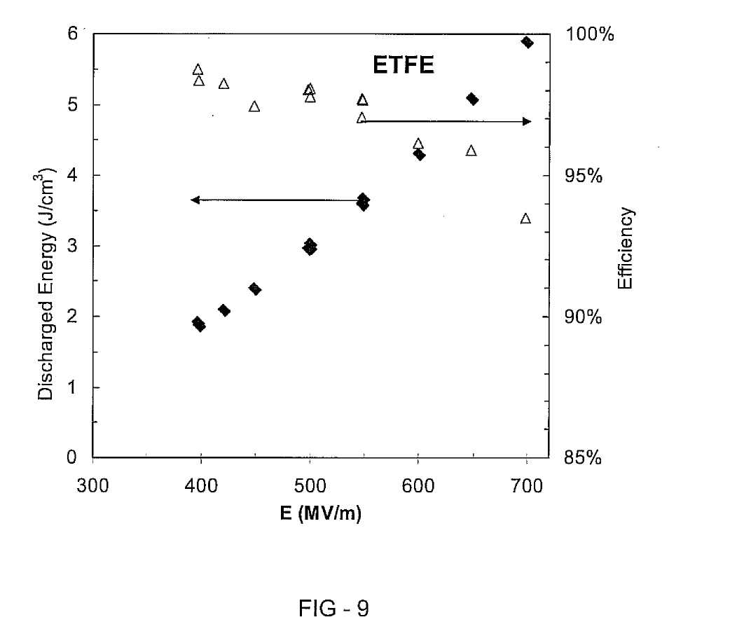

FIG. 9 shows the capacitor energy density (discharged) and charge-discharge efficiency of pure ETFE. The metallized film of ETFE has an energy density of 5.9 J/cm3 with a charge-discharge efficiency above 93%. Therefore, ETEE can be used alone (as in this example) or within a polymer blend, to make a polymer dielectric film for a high energy density, high temperature, and low dielectric loss capacitor device.

As discussed above, since ETFE has similar chemical structure as P(VDF-HFP), and they are thermodynamically miscible. A blend of 70/30 ETFE/P(VDF-HFP) can have a Weibull dielectric breakdown strength of 521 MV/m, and a dielectric constant of 3.8, DF of 0.58% at 1 kHz and room temperature. At 500 MV/m, its discharged energy density is 4.83 J/cm3 with a charge-discharge efficiency of 96.1%.

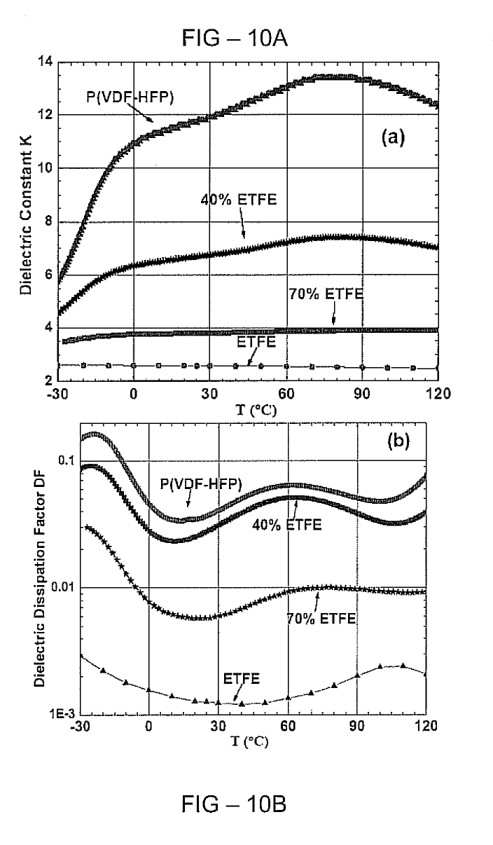

FIG. 10 presents typical charge-discharge curves of the stretched 70/30 ETFE/P(VDF-HFP) blend capacitor film at different peak voltages. At 650 MV/m, the discharged energy density is 8.41 J/cm³ with a charge-discharge efficiency of 94.3%. The volume resistivity of the 70% ETFE blend increases to 9.4×10¹⁵ Ω·cm.

### Example 1

Commercial grade P(VDF-HFP) (with 10% HFP) and PC pellets were ground and mixed with a shaker. The mixed powder was blown into film by the extrusion blown process. The extruder and die temperatures are set at 250° C. Blown films with 40% and 50% PC were obtained. The blown films were further stretched. A gold electrode was sputtered on both sides of the film as the electrodes. The 40% blend has a dielectric constant of 5.4 and a dissipation factor of 1.2% at 1 kHz and 25° C. Its Weibull dielectric breakdown strength is 485 MV/m, discharge energy density is 7.6 J/cm³ and charge-discharge efficiency is 86% at 500 MV/m. The 50% blend has a dielectric constant of 4.7 and a dissipation factor of 0.8% at 1 kHz and room temperature. Its Weibull dielectric breakdown strength is 542 MV/m, discharge energy density is 6.0 J/cm³ and charge-discharge efficiency is 92.8% at 500 MV/m.

### Example 2

### Comparative

Commercial grade P(VDF-HFP) (with 10% HFP) and PC pellets were ground and mixed with a shaker. The mixed powder was blown into film by the extrusion blown process. The extruder and die temperatures are set at 250° C. Blown film with 30% PC was obtained. However, the blown film is rigid and thick. It cannot be stretched.

### Example 3

Commercial grade P(VDF-HFP) (with 10% HFP) and PC pellets were ground and mixed with a shaker. The mixed powder was further processed with a twin screw extruder at 210-230° C. to get blend pellets. The blend pellets were blown into film by the extrusion blown process. The extruder and die temperatures are set at 250° C. Blown films with 5% and 10% PC were obtained. The blown films were further stretched. A gold electrode was sputtered on both sides of the film as the electrodes. The blend capacitor films have Weibull dielectric breakdown strengths of 605 and 709 MV/m for the 5% and 10% PC compositions, respectively. However, the blends films have lower discharged energy density and lower charge-discharge efficiency as shown in Table 2.

### Example 4

### Comparative

Commercial grade P(VDF-HFP) (with 10% HFP) and PC pellets were ground and mixed with a shaker. The mixed powder was further processed with a twin screw extruder at 210-230° C. to get blend pellets. The blend pellets were blown into film by the extrusion blown process. The extruder and die temperatures are set at 250° C. Blown film with 20% PC was obtained. However, the blown film is rigid and cannot be stretched.

### Example 5

Commercial grade ETFE film with thickness of 25 μm was stretched 4 times and then annealed in an oven at 180° C. for 1 hour. Thin capacitor film of 6-8 μm was obtained. Gold electrode was sputtered on both sides. The metallized capacitor film has Weibull dielectric breakdown strength of 522, 588, and 468 MV/m at 25° C., 100° C., and 200° C., respectively. The metallized film has an energy of 5.9 J/cm³ with a charge-discharge efficiency above 93%.

### Example 6

Commercial grade P(VDF-HFP) (with 10% HFP) and ETFE pellets were ground and mixed with a shaker. The mixed powder was blown into film by the extrusion blown process. The extruder and die temperatures are set at 280° C. Blown films with 40% and 70% ETFE were obtained. The blown films were further stretched. Gold electrode was sputtered on both sides as electrode. The 40% ETFE blend has a dielectric constant of 6.2 and a dissipation factor of 1.8% at 1 kHz and room temperature. The 70% ETFE blend has a dielectric constant of 3.75 and a dissipation factor of 0.6% at 1 kHz and room temperature. Its Weibull dielectric breakdown strength is 521 MV/m, discharge energy density is 8.41 J/cm³ and charge-discharge efficiency is 94.3% at 650 MV/m. The volume resistivity of the 70% ETEE blend increases to 3.7×10¹⁴ Ω·cm.

### Other Examples

Examples of the present invention include polymer blends of PVDF-based polymers with lower dielectric constant polymers having a dielectric loss lower than the PVDF-based polymer. The β phase of PVDF films reduces the charge-discharge efficiency, and some examples of the present invention include new material formulations which reduce the β phase formation and hence maximize the a phase content, and stretched capacitor films from these formulations have a higher charge-discharge efficiency.

Examples of the present invention include PC/PVDF-based polymer blends with compositions 30/70 to 80/20 weight ratio of PC to PVDF-based polymer, more particularly 40/60-70/30 weight ratio. These blends are well suited for film capacitor applications, allowing film processing and biaxial orientation to achieve thin capacitor films. In other examples, other type-B (second polymer) components, as described above, can be used instead of PC.

Examples of PVDF-based polymers that may be used in polymer blends of the present invention are described in US2009/0030152 to Zhang et al., incorporated herein by reference. A PVDF-based polymer may be a homopolymer (PVDF), a copolymer, a terpolymer, or a blend of such polymers, for example a blend such as described in US2009/0030152.

Examples of the present invention include polymer blends including one or more polar fluoropolymers, the blend having a melting temperature that is increased relative to an unblended polar fluoropolymer.

Examples of the present invention include novel material formulations, such as polymer blends, which can reduce the beta phase and maximize the alpha phase content. Stretched capacitor films from these formulations have high charge-discharge efficiency. In particular, polymer blends of a first polymer and a second polymer, where the first polymer is a PVDF-based fluoropolymer and the second polymer is a relatively low dielectric constant polymer, were found to give improved properties, where the weight percentage of the second polymer in the polymer blend was at least 30%, for example in the range 30%-80%, more particularly from 40%-70%, inclusive.

Some examples of the present invention include polymer blends of fluoropolymers and non-fluoropolymers, the weight percentage of the non-fluoropolymer polymeric components being at least 30%, for example in the range 30%-80%, more particularly from 40%-70%, inclusive.

Examples of the present invention include PC/PVDF-based polymer blends with weight ratio compositions from 30/70 to 80/20, and these polymer blends were found to give improved electrical properties that were more suitable for film capacitor applications.

In some examples, compatibilizers such as low molecular weight compounds (non-polymers), functionalized polymers, copolymers, and the like can be used as to improve the mechanical properties of the polymer blend. Example compatibilizers are described in U.S. Pat. No. 5,496,889.

Device Applications

Examples of the present invention include applications, such as devices for storing, and/or controlling, and/or manipulating of charge and/or electric energy, for example for use in hybrid electric vehicles, defibrillators, and the like.

A film capacitor may comprise a high temperature polymer blend, including a polar fluoropolymer component and a second polymer component, with dielectric loss lower than 0.2% and good film manufacturability. These capacitor films can be orientated at least in one direction to make thinner films with improved performance. The capacitors can made by winding metallized films, plain films with metal foils, or hybrid construction where the films comprising the new compositions. The capacitors can also be made with a multilayer construction where the films are metallized.

An example device for storing, and/or controlling, and/or manipulating of charge and/or electric energy has a polymer film as the dielectric layer, the polymer film comprising a blend of a fluoropolymer (a type-A polymer) and a second polymer (a type-B polymer), the second polymer having a low dielectric dissipation factor and high volume resistivity compared with the first polymer. For example the volume resistivivity of the second polymer (the type-B polymer) may be selected as at least one (or two) orders of magnitude greater than the first polymer (the type-A polymer).

An example polymer blend may include the following two polymeric components.

(i) A fluoropolymer (type-A polymer), which may be a PVDF-based homopolymer, copolymer or terpolymer selected from the group consisting of:

PVDF, P(VDF-CTFE), P(VDF-CTFE), P(VDF-HFP), P(VDF-CDFE), P(VDF-TrFE-CTFE), P(VDF-TrFE-CFE), P(VDF-TrFE-HFP), P(VDF-TrFE-CDFE), P(VDF-TFE-CTFE), P(VDF-TFE-CFE), P(VDF-TFE-HFP), P(VDF-TFE-HFP), P(VDF-TFE-CTFE), and P(VDF-TFE-CDFE) (the abbreviations are defined elsewhere); or a fluoropolymer blend including one or more of these polymers.

In some examples, the PVDF-based polymer is selected from copolymers or terpolymers of VDF with other monomers.

In some examples, the polymer or polymer blends of type-A may have a dielectric constant above 5.

(ii) A second polymer (type-B), which may have a low dielectric dissipation factor and high volume resistivity, compared to the type-A polymer, and can be selected from the group of polymers consisting of: polycarbonate, poly(ethylene-co-tetrafluoroethylene) (ETFE), poly(2,6-dimethy-1,4-phenylene oxide) (PPO), poly(ethylene-co-tetrafluoroethylene) (ETFE), polyethylene naphthalate (PEN), poly(phenylene sulfide) (PPS), or blends of one or more of such polymers. Other example type-B polymers are described above, for example the polymers shown in Table I.

In some examples, the second polymer may be polypropylene. For example, the polymer blend may comprise polypropylene as the second polymer (blending polymer) in a blend with a PVDF-based fluoropolymer (a type-A polymer).

In some examples, the second polymer is polycarbonate. In some examples, the second polymer is a polyester.

In some examples, the polymer blend may include a compatibilizer such as acrylate, acrylate acid, epoxy, or maleic anhydride modified polypropylene or polyethylene to facilitate the miscibility of the polymers within the polymer blend.

The polymer(s) (or polymer blend(s)) of type-B may be selected to have one or more (e.g. all) of the following parameters: a dielectric a dissipation factor (DF) lower than 5%; a dielectric constant above 2.0; and a volume resistivity above 10¹⁴ Ω·cm.

In some examples, the mol % of CTFE, or CFE, or HFP, or CDFE in the fluoropolymer component(s) (e.g. PVDF-based copolymers and terpolymers) may be in the range from 0 mol % to about 20 mol %. The mol % of TrFE or TFE in the copolymers or terpolymers may be in the range from 0 mol % to about 30 mol %.

The composition of an example polymer blend comprising a first (A-type) polymer and a second (B-type) polymer may be in the range from 70/30 to 20/80 by weight ratio (expressed as a weight ratio of first polymer/second polymer). In other examples, the weight ratio may be in the range 60/40 to 30/70. The ratio ranges may be inclusive, and may be approximate ranges. The same weight ratio ranges may also be used for blends of one or more first polymers with one or more second polymers, the weight ratio being that of the blend of one or more first polymers relative to the blend of one or more second polymers.

The polymer film can be produced from solution mixing and casting, melt extrusion casting, melt extrusion blowing, or any other appropriate process.

The polymer film can be stretched in either one direction or two directions with stretching ration from 1.1× to 9× (e.g. 1.5×-9×) of the original length in each direction (which may be termed the stretching ratio).

A polymer film, such as a dielectric layer, formed from a polymer blend as described herein may have one or more of the following properties: a dielectric constant above 4; an energy density above 4 J/cm3 at field above 500 MV/m; a charge-discharge efficiency higher than 75%; a volume resistivity is higher than 10¹³ Ω·cm at 25 MV/m; and/or a DC dielectric breakdown strength above 400 MV/m.

An example device for storing, and/or controlling, and/or manipulating of charge and/or electric energy has dielectric layer including a polymer film. The polymer film may comprise a poly(ethylene-co-tetrafluoroethylene) copolymer. In some examples, the polymer film may comprise mostly (>50% by weight), or substantially all poly(ethylene-co-tetrafluoroethylene). The device may be a capacitor, a FET with a polymer thin film gate dielectric layer, or other device. The poly(ethylene-co-tetrafluoroethylene) copolymer may be blended with one or more other fluoropolymers, such as PVDF-based polymers.

An example capacitor includes a thin film dielectric layer, the thin film dielectric layer comprising a blend of poly(ethylene-co-tetrafluoroethylene) (ETFE) and a second polar fluoropolymer, wherein the second polar fluoropolymer is selected from a group of polymers consisting of: polyvinylidene fluoride (PVDF), poly(vinylidene fluoride-co-chlorotrifluoroethylene) (PVDF-CDFE), poly(vinylidene fluoride-co-hexafluoropropylene) (PVDF-HFP), poly(vinylidene fluoride-co-chlorofluoroethylene) (PVDF-CFE), poly(vinylidene fluoride-co-chlorodifluoroethylene) (PVDF-CDFE), poly(vinylidene fluoride-co-trifluoroethylene-co-chlorofluoroethylene) (PVDF-TrFE-CTFE), poly(vinylidene fluoride-co-trifluoroethylene-co-chlorotrifluoroethylene) (PVDF-TrFE-CTFE), poly(vinylidene fluoride-co-trifluoroethylene-co-hexafluoropropylene) (PVDF-TrFE-HFP), poly(vinylidene fluoride-co-trifluoroethylene-co-chlorodifluoroethylene) (PVDF-TrFE-CDFE), poly(vinylidene fluoride-co-tetrafluoroethylene-co-chlorofluoroethylene) (PVDF-TFE-CFE), poly(vinylidene fluoride-co-tetrafluoroethylene-co-chlorotrifluoroethylene) (PVDF-TFE-CTFE), poly(vinylidene fluoride-co-tetrafluoroethylene-co-hexafluoropropylene) (PVDF-TFE-HFP), and poly(vinylidene fluoride-co-tetrafluoroethylene-co-chlorodifluoroethylene) (PVDF-TFE-CDFE). Examples of the present invention also include polymer blends of poly(ethylene-co-tetrafluoroethylene) (ETFE) and a second polar fluoropolymer, and their applications in any dielectric layer.

A polymer blend according to an example of the present invention comprises a first polymer component, the first component comprising one or more fluoropolymers selected from a group of fluoropolymers consisting of polymers, copolymers, and terpolymers of vinylidene difluoride, and a second polymer component selected so as to have a volume resistivity greater than the first polymer component and a dielectric loss less than the first polymer component, so as to obtain a polymer blend having greater resistivity and lower dielectric loss than the first polymer component. The weight percentage of fluoropolymers in the polymer blend may be in the range 20%-70%. The first polymer may be a copolymer or terpolymer of VDF. The first polymer may include a mol % of CTFE, or CFE, or HFP, or CDFE in a copolymer or terpolymer in the range from 0 mol % to about 20 mol %, or a mol % of TrFE or TFE in a terpolymer in the range from 0 mol % to about 30 mol %. The second polymer is selected from a group of polymers consisting of polystyrene, polycarbonate, poly(2,6-dimethy-1,4-phenylene oxide) (PPO), polyethylene naphthalate (PEN), and poly(phenylene sulfide) (PPS), or may be another polymer.

A charge or energy storage dielectric layer may be a dielectric layer of a polymer thin film capacitor. Using the improved polymer blends described herein as the dielectric layer of the capacitor, the discharge time for release of 90% of the stored energy of the polymer thin film capacitor (˜0.1 μF) to a 1 kΩ load can be less than 10 ms. Film capacitors can be made from metallized films, alternating layers of film and metal foil, or hybrid metallized film and foil construction. The discharge efficiency can be higher than 75%. The device may include a multilayer polymer dielectric layer.

A polymer film comprising a polymer blend according to an example of the present invention can be used as the gate dielectric film in a Field Effect Transistor (FET).

The present invention has been described with particular reference to representative examples. It should be understood that the foregoing descriptions and examples are only illustrative of the invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

Having described our invention, we claim:

1. A device for storing, and/or controlling, and/or manipulating electrical charge and/or electric energy,
the device including a dielectric layer,
the dielectric layer including a thin film of a polymer blend, the polymer blend comprising:
a first polymer, the first polymer being a fluoropolymer; and
a second polymer,
the second polymer being selected so as to have a volume resistivity greater than the first polymer and a dielectric loss less than the first polymer, so as to obtain a dielectric layer having a greater resistivity and a lower dielectric loss than the fluoropolymer,
the weight percentage of second polymer in the polymer blend being between 30% and 80%.

2. The device of claim 1, wherein the first polymer is a polymer, copolymer, or terpolymer of vinylidene difluoride.

3. The device of claim 2, wherein the first polymer is selected from a group of polymers consisting of:
polyvinylidene fluoride (PVDF), poly(vinylidene fluoride-co-chlorotrifluoroethylene) (PVDF-CTFE), poly(vinylidene fluoride-co-hexafluoropropylene) (PVDF-HFP), poly(vinylidene fluoride-co-chlorofluoroethylene) (PVDF-CFE), poly(vinylidene fluoride-co-chlorodifluoroethylene) (PVDF-CDFE), poly(vinylidene fluoride-co-trifluoroethylene-co-chlorofluoroethylene) (PVDF-TrFE-CFE), poly(vinylidene fluoride-co-trifluoroethylene-co-chlorotrifluoroethylene) (PVDF-TrFE-CTFE), poly(vinylidene fluoride-co-trifluoroethylene-co-hexafluoropropylene) (PVDF-TrFE-HFP), poly(vinylidene fluoride-co-trifluoroethylene-co-chlorodifluoroethylene) (PVDF-TrFE-CDFE), poly(vinylidene fluoride-co-tetrafluoroethylene-co-chlorofluoroethylene) (PVDF-TFE-CFE), poly(vinylidene fluoride-co-tetrafluoroethylene-co-chlorotrifluoroethylene) (PVDF-TFE-CTFE), poly(vinylidene fluoride-co-tetrafluoroethylene-co-hexafluoropropylene) (PVDF-TFE-HFP), and poly(vinylidene fluoride-co-tetrafluoroethylene-co-chlorodifluoroethylene) (PVDF-TFE-CDFE).

4. The device of claim 2, the first polymer including a mol % of CTFE, or CFE, or HFP, or CDFE in a copolymer or terpolymer in the range from 0 mol % to about 20 mol %.

5. The device of claim 2, the polymer blend including a mol % of TrBE or TFE in a terpolymer in the range from 0 mol % to about 30 mol %.

6. The device of claim 1, the weight percentage of second polymer in the polymer blend being between 40% and 70%,

7. The device of claim 1, wherein the second polymer is selected from a group of polymers consisting of:
polystyrene, polycarbonate, poly(2,6-dimethy-1,4-phenylene oxide) (PPO), polyethylene naphthalate (PEN), and poly(phenylene sulfide) (PPS).

8. The device of claim 1, wherein the second polymer is a blend including at least one polymer from the group of polymers consisting of polystyrene, polycarbonate, poly(2,6-dimethy-1,4-phenylene oxide) (PPO), polyethylene naphthalate (PEN), and poly(phenylene sulfide) (PPS).

9. The device of claim 1, wherein the first polymer is a fluoropolymer blend.

10. The device of claim 1, wherein the second polymer is polycarbonate.

11. The device of claim 1, wherein the second polymer is polypropylene

12. The device of claim 11, further comprising a compatibilizer to facilitate miscibility of the first polymer and the second polymer.

13. The device of claim 12, wherein the compatibilizer is an acrylate, acrylate acid, epoxy, a maleic anhydride modified polypropylene, or a maleic anhydride modified polyethylene.

14. The device of claim 1, the second polymer having a dielectric dissipation factor (DF) less than 5%.

15. The device of claim 1, the second polymer having a volume resistivity greater than 10¹⁴ Ω·cm.

16. The device of claim 1, wherein the second polymer has a dielectric constant above 2.

17. The device of claim of claim 1, the polymer blend having a dielectric constant approximately equal to or higher than 4.

18. The device of claim 1, the polymer blend having an energy density above 4 J/cm³ at field above 500 MV/m.

19. The device of 1, the device being a capacitor.

20. The device of claim 19, wherein discharge time for release of 90% of the stored energy of the thin film capacitor (˜0.1 μF) to a 1 kΩ load is less than 10 ms.

21. The device of claim 19, wherein the thin film capacitor comprises metallized films, alternating layers of film and metal foil, or hybrid metallized film and foil construction.

22. The device of claim 19, wherein discharge efficiency of the capacitor is higher than 75%.

23. The device of claim 19, wherein the dielectric layer includes a multilayer polymer dielectric film.

24. The device of claim 1, wherein the device is a Field Effect Transistor (FET), and the dielectric layer is the gate dielectric film.

25. The device of claim 1, the polymer blend having a volume resistivity higher than 10¹³ Ω·cm at 25 MV/m, and a DC dielectric breakdown strength above 400 MV/m.

26. The device of claim 1, the polymer blend being stretched in at least one direction.

27. The device of claim 26, wherein the polymer blend is stretched in either one direction or two directions with a stretching ratio in each stretched direction of between 2× and 9×, inclusive.

28. A capacitor including a thin film dielectric layer, the thin film dielectric layer including poly(ethylene-co-tetrafluoroethylene) (ETFE).

29. A capacitor including a thin film dielectric layer, the thin film dielectric layer comprising a blend of poly(ethylene-co-tetrafluoroethylene) (ETFE) and a second polar fluoropolymer, wherein the second polar fluoropolymer is selected from a group of polymers consisting of:
polyvinylidene fluoride (PVDF), poly(vinylidene fluoride-co-chlorotrifluoroethylene) (PVDF-CTFE), poly(vinylidene fluoride-co-hexafluoropropylene) (PVDF-HFP), poly(vinylidene fluoride-co-chlorofluoroethylene) (PVDF-CFE), poly(vinylidene fluoride-co-chlorodifluoroethylene) (PVDF-CDFE), poly(vinylidene fluoride-co-trifluoroethylene-co-chlorofluoroethylene) (PVDF-TrFE-CFE), poly(vinylidene fluoride-co-trifluoroethylene-co-chlorotrifluoroethylene) (PVDF-TrFE-CTFE), poly(vinylidene fluoride-co-trifluoroethylene-co-hexafluoropropylene) (PVDF-TrFE-HFP), poly(vinylidene fluoride-co-trifluoroethylene-co-chlorodifluoroethylene) (PVDF-TrFE-CDFE), poly(vinylidene fluoride-co-tetrafluoroethylene-co-chlorofluoroethylene) (PVDF-TFE-CFE), poly(vinylidene fluoride-co-tetrafluoroethylene-co-chlorotrifluoroethylene) (PVDF-TFE-CTFE), poly(vinylidene fluoride-co-tetrafluoroethylene-co-hexafluoropropylene) (PVDF-TFE-HFP), and poly(vinylidene fluoride-co-tetrafluoroethylene-co-chlorodifluoroethylene) (PVDF-TFE-CDFE).
